(19) United States
(12) Patent Application Publication
(10) Pub. No.: US 2023/0301325 A1
(43) Pub. Date: Sep. 28, 2023

(54) VEGAN FERMENTED PEPPERONI OR SALAMI ANALOGUE PRODUCT

(71) Applicant: SOCIETE DES PRODUITS NESTLE S.A., Vevey (CH)

(72) Inventors: CHRISTOPHE JOSEPH ETIENNE SCHMITT, Linwood, NJ (US); STEPHANE DUBOUX, St-Prex (CH); JOCHEN WEISS, Kohlberg (DE); EVA HERZ, Stuttgart (DE); DOMINIC OPPEN, Ostfildern (DE); KURT HERRMANN, Hildrizhausen (DE); MYRIAM ESTHER LOEFFLER, Stuttgart (DE); JOHANNES DREHER, Stuttgart (DE)

(21) Appl. No.: 18/041,828

(22) PCT Filed: Aug. 19, 2021
(86) PCT No.: PCT/EP2021/072982

§ 371 Date: Feb. 16, 2023

(30) Foreign Application Priority Data
Aug. 19, 2020 (EP) 20191781.2

(51) Int. Cl. A23J 3/22; A23J 3/14; A23L 3/40

(52) U.S. Cl. CPC A23J 3/227; A23J 3/14; A23L 3/40

(57) ABSTRACT

The invention relates to vegan fermented pepperoni or salami analogue products, and methods of making thereof, said methods comprising preparing a pepperoni or salami analogue batter mixture; ripening the mixture; heating the mixture; and drying the mixture to form a vegan fermented pepperoni or salami analogue product.

### BACKGROUND OF THE INVENTION

Consumers are looking for plant-based meat analogues with good taste and texture. This includes salami and pepperoni type products which can be consumed on their own or on a pizza. Current offerings on the market are not naturally fermented but either use chemical acidifier or are not fermented at all. The taste and texture of such products are therefore not appealing. In addition, those products generally contain some stabilizers and are therefore not perceived as very clean label by consumers. Current products are not optimized for baking, and become brittle and unacceptable. They may also be difficult to slice due to poor internal cohesion. A clear need exists for improved vegan fermented pepperoni or salami analogue products which address the above problems.

### SUMMARY OF THE INVENTION

The inventors have developed a method for making a plant-based pepperoni or salami that combines plant protein extrudate, fat mimetic and binder in an optimum ratio and which serves as a suitable environment for starter cultures.

The invention relates in general to a method of making a fermented pepperoni or salami analogue product, said method comprising
a. Preparing a pepperoni or salami analogue batter mixture;
b. Ripening the mixture;
c. Heating the mixture; and
d. Drying the mixture to form a fermented pepperoni or salami analogue product.

The invention further relates to a fermented pepperoni or salami analogue product comprising plant protein extrudate, fat mimetic, gluten, and additives, made by a method as described herein.

The invention further relates to a vegan or vegetarian foodstuff comprising the fermented pepperoni or salami analogue product as described herein.

The invention further relates to the use of a bacterial culture comprising Lactobacillus species, preferably Lactobacillus sakei, Lactobacillus plantarum or Lactobacillus curvatus, preferably L. sakei or L. plantarum, in the production of a vegan fermented pepperoni or salami analogue product.

### BRIEF DESCRIPTION OF THE FIGURES

FIG. 1 Growth kinetics of the different starter cultures (Table 1) investigated in either MRS (lactic acid bacteria) or nutrient broth over a period of 48 h, at 30° C.; (n=4).

FIG. 2 Growth kinetics of the different starter cultures (Table 1) determined in the plant protein-based pepperoni analogue matrix (initial inoculation concentration 10⁶ CFU/g) over a period of 68 h, at 30° C.; (n=4).

FIG. 3 Development of the pH values in the pepperoni analogue matrices that have been inoculated with one of the starter cultures each (Table 1; initial inoculation concentration 10⁶ CFU/g) over a period of 68 h, at 30° C.; (n=3).

FIG. 4 Development of the pH values in the pepperoni analogue matrices that have been inoculated with a mixture of L. plantarum 1753 and S. carnosus 1052 or L. sakei 1692 and S. carnosus 971, respectively (initial inoculation concentration 10⁶ CFU/g) as well as the corresponding growth kinetics determined over a period of 68 h, at 30° C.; (n=3 for pH, n=4 for viable counts).

FIG. 5 pH of plant protein-based pepperoni analogues that have been produced with L. plantarum 1753 and S. carnosus 1052 (10⁶ CFU/g) after 18 h of fermentation at 24° C. in dependency of percent added water to the pepperoni batter (5-30%) and hence with different water (5-30%) to extrudate (55-30%) rations. Initial pH was in the range of 5.6-5.8.

FIG. 6 Drying kinetics of pepperoni analogues that have been produced with different amounts of additional water (0-25%). The data point at −5 h refers to the weight right after filling, whereas the 0 h data point refers to the weight after the heating step. Samples were dried at 15° C. and 80% relative humidity.

FIG. 7 Weight loss of prepared samples after fermentation, heat processing, and 48 h of drying at 15° C. at 80-85% RH. A=Pea Protein Isolate A from a commercial source (referred to herein as PPI A), B=Pea Protein Isolate B from a commercial source (referred to herein as PPI B), SPI=Soy Protein Isolate from a commercial source, lf=15% fat, hf=20% fat, ll=25% liquid; control=sample V3.6 (30% added water and 30% TVP).

FIG. 8 Images of pepperoni analogue slices (V7). Images may not always represent the pepperoni analogue correctly, since some samples were inhomogeneous. A=PPI A, B=PPI B, SPI=Soy Protein Isolate from a commercial source, lf=15% fat, hf=20% fat, ll=25% liquid; control=sample V3.6.

FIG. 9 Images of pepperoni analogues baked on pizza. Pizza was baked for 12 min at 180° C.

### EMBODIMENTS OF THE INVENTION

The invention relates in general to a method of making a fermented pepperoni or salami analogue product, said method comprising preparing a pepperoni or salami analogue batter mixture, said mixture comprising a wet mixture of plant protein source, bacterial culture, and gluten; ripening or fermenting the mixture; heating the mixture; and drying the mixture.

In particular, the invention relates to a method of making a fermented pepperoni or salami analogue product, said method comprising preparing a pepperoni or salami analogue batter mixture, said mixture comprising plant protein extrudate, bacterial culture, fat mimetic, gluten, and liquid; ripening or fermenting the mixture; heating the mixture; and drying the mixture.

In particular, the invention relates to a method of making a fermented pepperoni or salami analogue product, said method comprising preparing a pepperoni or salami analogue batter mixture, said mixture comprising plant protein extrudate, bacterial culture, fat mimetic, gluten, and liquid; ripening or fermenting the mixture; heating the mixture; and drying the mixture.

In particular, the invention relates to a method of making a fermented pepperoni or salami analogue product, said method comprising preparing a pepperoni or salami analogue batter mixture, said mixture comprising plant protein extrudate, bacterial culture comprising Lactobacillus, fat mimetic, gluten, and water; ripening or fermenting the mixture; heating the mixture; and drying the mixture.

In particular, the invention relates to a method of making a vegan fermented pepperoni or salami analogue product, said method comprising
a. Preparing a pepperoni or salami analogue batter mixture, said mixture comprising
i. plant protein extrudate,
ii. bacterial culture comprising Lactobacillus,
iii. fat mimetic,
iv. gluten,
v. additives, and
vi. water;
b. Ripening the mixture;
c. Heating the mixture to a temperature of at least 70° C., preferably to about 85° C.; and
d. Drying the mixture at a relative humidity of 90% or less, preferably at a relative humidity of 85% or less, to form a vegan fermented pepperoni or salami analogue product.

In some embodiments, the plant protein extrudate is texturized. In some embodiments, the plant protein extrudate has a dry matter content of 45 to 60 wt %.

In some embodiments, the plant protein extrudate comprises pea protein isolate and/or soy protein isolate. In some embodiments, the pea protein isolate and soy protein isolate are devoid or substantially devoid of free sugars.

In some embodiments, the bacterial culture comprises Lactobacillus sakei, or Lactobacillus plantarum, or Lactobacillus curvatus, preferably Lactobacillus sakei, preferably L. sakei NCC 1692 or L. plantarum 1753. In one embodiment, the bacterial culture comprises Lactobacillus sakei, preferably L. sakei NCC 1692. In one embodiment, the bacterial culture comprises Lactobacillus plantarum., preferably L. plantarum 1753. In one embodiment, the bacterial culture comprises Lactobacillus curvatus. In one embodiment, the bacterial culture comprises L. curvatus.

In some embodiments, the bacterial culture further comprises Staphylococcus carnosus, preferably S. carnosus NCC 971 or S. carnosus NCC 1052.

In some embodiments, the bacterial culture comprises MRS or nutrient broth.

In some embodiments, the bacterial culture comprises 10⁸ to 10⁹ cfu/ml before adding to the batter mixture.

It was found that adding sugar to batter mixtures led to overly high levels of acidification with most bacterial strains tested. In some embodiments, the batter mixture is devoid or substantially devoid of added sugar.

In some embodiments, the fat mimetic comprises an oil phase and a soy protein isolate (SPI) suspension, preferably about 70% (w/w) oil-phase and about 30% (w/w) of a soy protein isolate (SPI) suspension.

In some embodiments, the fat mimetic comprises about 30% (w/w) of a 12% soy protein isolate (SPI) suspension.

In some embodiments, the oil phase comprises canola oil, preferably 100% canola oil.

In some embodiments, the fat mimetic comprises soy protein isolate and transglutaminase.

In some embodiments, the plant protein extrudate and fat mimetic are comminuted before adding to the batter mixture. This has a positive influence on the binding and might be the reason for improved fat embedment.

In some embodiments, the additives comprise red beet powder.

The correct amount of water was added in order to obtain a product with enough structural integrity to be commercially sliced, but not so much that the product goes into a glassy state. In some embodiments, the batter mixture comprises between 5 to 50 wt % water.

In some embodiments, the batter mixture comprises 40-50 wt % plant protein extrudate and 10-20 wt % water before ripening.

In some embodiments, the batter mixture comprises about 20 wt % fat mimetic and about 20 wt % wheat gluten before ripening. In some embodiments, the batter mixture comprises about 15 wt % fat mimetic and about 20 wt % wheat gluten before ripening.

Protein isolate suspensions were found to have potential for increasing binding while maintaining a good processability of the pepperoni analogue mass. In some embodiments, the batter mixture further comprises soy protein isolate or pea protein isolate present in the water. Water binding and cohesiveness of pepperoni analogues produced with soy protein isolate was found to be improved compared to samples produced with pea protein isolates. In one embodiment, the batter mixture further comprises soy protein isolate in the water. In one embodiment, soy protein isolate is added as a 5% SPI suspension in the water. This amount leads to a well bound product with a very good fat visibility.

In some embodiments, the mixture is transferred to a bag or casing for filling before ripening.

In some embodiments, the mixture is ripened until it reaches pH 6.0 or less, preferably pH 4.6 to 6.0, more preferably pH 5.0 to 5.8.

In some embodiments, the mixture is subjected to a smoking step after ripening.

In some embodiments, the mixture is heated by steam heating, preferably at about 90° C. so that the internal temperature of the mixture is about 85° C.

In some embodiments, the mixture loses between 5-20% of its original weight during drying.

The invention further relates to a fermented pepperoni or salami analogue product comprising plant protein extrudate, fat mimetic, gluten, and additives, optionally made by a method as described herein. The fermented pepperoni or salami analogue product is devoid or substantially devoid of animal products.

The invention further relates to a vegan or vegetarian foodstuff comprising the pepperoni or salami analogue product as described herein. In some embodiments, said vegan or vegetarian foodstuff is a pizza.

The invention further relates to the use of a bacterial culture comprising L. sakei and S. carnosus, preferably L. sakei NCC 1692 and S. carnosus NCC 971, in the production of a vegan fermented pepperoni or salami analogue product.

### DETAILED DESCRIPTION OF THE INVENTION

### Pepperoni Batter Mixture

The pepperoni batter mixture comprises plant protein extrudate, bacterial culture comprising Lactobacillus, fat mimetic, gluten, additives, and water.

For example, the batter mixture may comprise 25 to 40 wt % plant protein extrudate, 15 to 25 wt % fat mimetic, 15 to 25 wt % gluten, and 5 to 35 wt % water.

Preferably the batter mixture comprises 30 to 35 wt % plant protein extrudate, about 20 wt % fat mimetic, about 20 wt % gluten, and 25 to 30 wt % water.

Preferably, the batter mixture further comprises a pea protein isolate solution and/or a soy protein isolate solution, preferably a 5% protein isolate solution, most preferably a soy protein isolate solution.

Preferably, the batter mixture has no added sugars, for example no added sucrose or dextrose.

### Salami Batter Mixture

The salami batter mixture comprises plant protein extrudate, bacterial culture comprising Lactobacillus, fat mimetic, gluten, additives, and water.

For example, the batter mixture may comprise 10 to 20 wt % plant protein extrudate, preferably about 14 wt % plant protein extrudate, 15 to 25 wt % fat mimetic, preferably about 20 wt % fat mimetic, 20 to 35 wt % gluten, preferably about 26 wt % wheat gluten, and 5 to 35 wt % water.

Preferably the batter mixture comprises 12 to 18 wt % plant protein extrudate, about 20 wt % fat mimetic, about 26 wt % gluten, and 25 to 30 wt % water.

Preferably, the batter mixture further comprises a pea protein isolate solution and/or a soy protein isolate solution, preferably a 5% protein isolate solution, most preferably a soy protein isolate solution.

Preferably, the batter mixture has no added sugars, for example no added sucrose or dextrose.

### Plant Protein Extrudate

The plant protein extrudate preferably is preferably texturized. It has a preferred dry matter content of between 45 to 60 wt %, preferably 50 to 55 wt %.

The plant protein extrudate preferably comprises pea protein isolate and/or soy protein isolate and/or wheat gluten. The extrudate can, for example, be prepared using pea protein isolate, and wheat gluten.

In one embodiment, the extrudate comprises wheat gluten, preferably between 10 to 30 wt % wheat gluten, more preferably between 10 to 20 wt % wheat gluten, more preferably 12 to 18 wt % wheat gluten, most preferably about 14.2 wt %.

The ingredients of the extrudate can, for example, be prepared using pea protein isolate, wheat gluten, soy protein isolate, rapeseed oil, and coloring ingredient.

The ingredients of the extrudate can, for example, be prepared using pea protein isolate, wheat gluten, starch, salt or iodized salt (NaCl), pea protein isolate, soy protein isolate, and rapeseed oil.

The mixture can be mixed for about 3 minutes to form homogenous dough. It can then be pumped, for example at about 15 kg/h.

A slit die can be connected to the exit of the extruder. The temperature of the die can be maintained below 100° C. Flavor and coloring ingredients can be injected to adjust the extruded product color and flavor to reproduce pork meat organoleptic properties. For example, they can be injected as an emulsion towards the end of the extrusion process.

The plant protein extrudate should have a water content above 45 g/100 g. This ensures hydration of the protein. The extrudate can be made by wet extrusion. It may be dried and then rehydrated before use.

The extrudate should remain at a moisture above the glass transition moisture of the protein or protein blend, which is used, at the consumption temperature (30-60° C.) (after frying or baking) of the finished product. The protein with the lowest glass transition moisture at 50° C. should be taken into account to define the minimum moisture of the semi-finished texturize product.

### Bacterial Culture

The bacterial culture preferably comprises Lactobacillus sakei, or Lactobacillus plantarum, or Lactobacillus curvatus preferably L. sakei NCC 1692 or L. plantarum. The bacterial culture may further comprise Staphylococcus carnosus, preferably S. carnosus NCC 971.

The bacterial culture preferably comprises MRS or nutrient broth. The bacterial culture is preferably grown under anaerobic conditions. The bacterial culture preferably comprises 10⁸ to 10⁹ cfu/ml before adding to the batter mixture.

The following microorganisms were deposited with the Collection Nationale de Cultures de Microorganismes (CNCM), Institut Pasteur, 25 rue du Docteur Roux, F-75724 PARIS Cedex 15, France, and have a CNCM deposit number and date of deposit as shown, where applicable.
S. carnosus NCC 1052 (CNCM 1-5400, deposited Jan. 2, 2019)
S. carnosus NCC 971 (CNCM 1-5398, deposited Jan. 2, 2019)
K. rhizophila NCC 1482 (CNCM 1-1586, deposited Jul. 6, 1995)
L. pseudomesenteroides NCC 2741 (CNCM 1-5067, deposited Aug. 3, 2016)
L. sakei NCC 1692 or L. sakei 1692 is identical to L. sake LTH673, which is publicly available, for example from the LTH collection, Hohenheim University, Institut fur Lebensmitteltechnologie, Stuttgart, Germany.

### Fat Mimetic

The fat mimetic is preferably an emulsion comprising between 60 to 80% (w/w) oil phase and 20 to 40% (w/w) soy protein isolate (SPI) suspension, preferably about 70% (w/w) oil-phase and about 30% (w/w) of a soy protein isolate (SPI) suspension. The emulsion preferably comprises about 30% (w/w) of a 12% soy protein isolate (SPI) suspension. The oil phase preferably comprises canola oil, preferably 100% canola oil. The fat mimetic preferably comprises transglutaminase. After adding transglutaminase, the emulsion is heated to about 40° C., preferably for about 1 hour. This ensures crosslinking of proteins by the transglutaminase. The emulsion is then heated, for example to about 90° C., followed by cooling and storage, preferably at about 2° C. Preferably, the fat mimetic is mixed with gluten before mixing with the other ingredients.

In one embodiment, the fat mimetic is pre-cut, preferably before chopping together with the other components. Preferably, the fat mimetic is pre-cut with a dicer, for example a meat dicer. This led to a what appeared to be a slightly more homogenous fat particle size distribution.

### Other Ingredients

The batter mixture further comprises gluten, additives, and water. The additives may comprise red beet powder. The batter mixture preferably comprises between 5 to 50 wt % water, preferably between 10 to 40 wt %. The additives may comprise sodium chloride, pepper, paprika, and/or salami aroma.

### Mixture Ripening

The mixture is preferably transferred to a bag or casing for filling before ripening. The mixture is preferably ripened until it reaches pH 6 or less, preferably pH 5.0 to 5.8. Ripening or fermentation may be performed for 20 to 28 hours, preferably for about 24 hours. The temperature used is between 20 to 24° C., preferably about 22° C. The relative humidity during ripening is about 95%.

### Heating

The mixture is heated at about 90° C. so that the internal temperature of the mixture is about 85° C. The preferred method of heating is steam heating.

### Drying

The pepperoni analogue batter mixture is preferably dried at about 15° C. The relative humidity during drying is preferably between 80-85% RH. The drying time is preferably about 48 hours.

The salami analogue batter mixture is preferably dried at about 15° C. The relative humidity during drying is preferably between 70-80% RH, preferably 75% RH. The drying time is preferably about 43 hours.

### Vegan Fermented Pepperoni Analogue Product

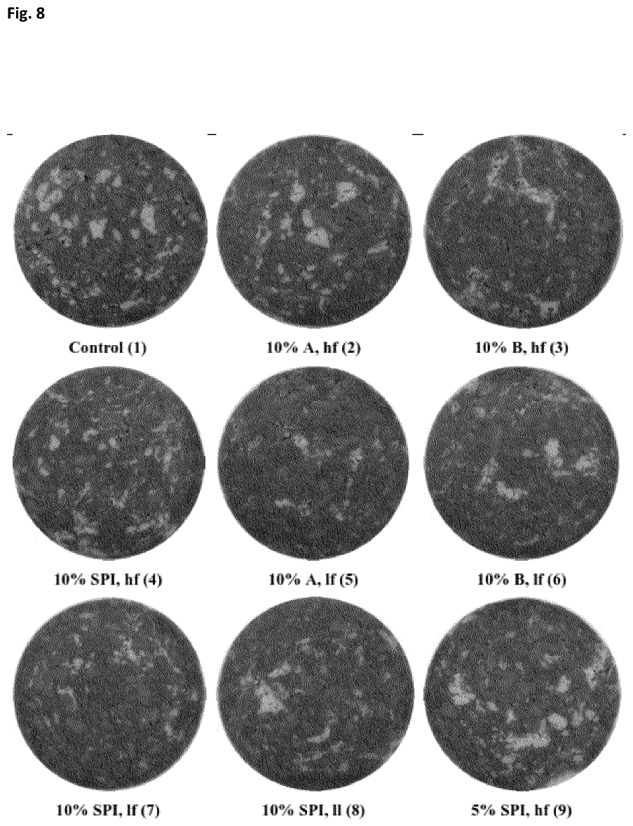

A vegan product is defined as being devoid of animal products, for example devoid of dairy products and meat products. A vegan fermented pepperoni analogue product of the invention has the look, taste, and texture of a meat-based fermented pepperoni product, for example as shown in FIG. 8.

### Definitions

As used herein, the singular forms “a,” “an” and “the” include plural referents unless the context clearly dictates otherwise. Thus, for example, reference to “a bacterial strain” or “the bacterial strain” includes two or more bacterial strains.

The words “comprise,” “comprises” and “comprising” are to be interpreted inclusively rather than exclusively. Likewise, the terms “include,” “including” and “or” should all be construed to be inclusive, unless such a construction is clearly prohibited from the context.

The compositions disclosed herein may lack any element that is not specifically disclosed. Thus, a disclosure of an embodiment using the term “comprising” includes a disclosure of embodiments y37 consisting essentially of and “consisting of the components identified. Similarly, the methods disclosed herein may lack any step that is not specifically disclosed herein. Thus, a disclosure of an embodiment using the term “comprising” includes a disclosure of embodiments “consisting essentially of” and “consisting of” the steps identified.

The term “and/or” used in the context of “X and/or Y” should be interpreted as “X,” or “Y,” or “X and Y.” Where used herein, the terms “example” and “such as,” particularly when followed by a listing of terms, are merely exemplary and illustrative and should not be deemed to be exclusive or comprehensive. Any embodiment disclosed herein can be combined with any other embodiment disclosed herein unless explicitly stated otherwise.

As used herein, “about” and “approximately” are understood to refer to numbers in a range of numerals, for example the range of −10% to +10% of the referenced number, preferably within −5% to +5% of the referenced number, more preferably within −1% to +1% of the referenced number, most preferably within −0.1% to +0.1% of the referenced number.

As used herein, a product “substantially devoid” of an ingredient means that none of that ingredient is added as such to the product, and that any of the ingredient present originates from minor traces or impurities present in other ingredients.

### EXAMPLES

### Example 1

### Optimization of Process Parameters

The growth behavior of various starter cultures was characterized in broth and in the pepperoni analogue matrix. Selected starter cultures from Table 1 were stored frozen at −80° C. Prior to inoculation, the cultures were transferred to fresh culture medium (MRS or nutrient broth) and incubated for 24 h at 30° C. This procedure was then repeated at least once, to ensure that the microorganisms are activated.

TABLE 1

| NCC | Taxonomie | Growth conditions |
|---|---|---|
| 1052 | Staphylococcus carnosus | 30° C. |
| 971 | Staphylococcus carnosus | 30° C. |
| 1482 | Kocuria rhizophila | 30° C. |
| 1692 | Lactobacillus sakei | 30° C.; anaerobe |
| 1753 | Lactobacillus plantarum | 30° C.; anaerobe |
| 253 | Lactobacillus curvatus | 30° C.; anaerobe |
| 2741 | Leuconostoc pseudomesenteroides | 30° C.; anaerobe |

For the growth curves in culture medium, two 15-mL tubes (examined in duplicate) were filled with either 9.9 mL MRS (LAB) or nutrient broth. After incubating the strains for 24 h at 30° C. (˜10⁸ CFU/mL), the suspension was diluted with peptone water (10⁴) and the culture medium tubes than inoculated to reach an initial concentration of approximately 10² CFU/mL. The tubes were then stored at 30° C. and samples analyzed after 0 h, 4 h, 12 h, 18 h, 24 h, and 48 h of incubation. Samples were then diluted (if necessary) and plated on either MRS agar (LAB), BP agar (Staphylococcus spp.) or on PCA (Kocuria rhizophila) using an automated spiral plater (Whitley Automatic Spiral Plater, Don Whitley Scientific Limited, West Yorkshire, UK). LAB strains (MRS) were incubated under anaerobic conditions (Anaerocult®), whereas the other strains were incubated under aerobic conditions for 48-72 h at 30° C. Colonies were then counted with an automated plate counter (Acolyte, Synbiosis, Cambridge, United Kingdom). All samples were prepared in duplicate (n=4 plates).

Starter cultures (Table 1) that have been activated in MRS (LAB) or nutrient broth, were applied to a pepperoni analogue matrix either alone or in combination (1 LAB strain & 1 Staphylococcus ssp.) using initial concentrations of ˜10⁶ CFU/g. Instead of filling the batter into casings, it was filled into 20 mL Nalgene cups with screwcaps. To avoid contamination, all needed equipment was cleaned with ethanol prior usage. Measurement points for microbial growth were set as follows: 0 h, 14 h, 18 h, 24 h, 44 h and 68 h. For each culture and measurement point, one Nalgene cup was filled. In order to determine the viable cell counts in the pepperoni analogue matrix, always two samples (10 g/sample) were taken out of the Nalgene cup using sterile spatulas. Each of the 10 g samples was then put into a stomacher bag and 90 mL 0.5%—peptone water added. Afterwards, the bags were stomached for 15 s, using a stomacher (400 circulator Seward Limited, West Sussex, UK). Stomached samples were then diluted (if necessary), plated, incubated (30° C. 48-72 h), and counted. All samples were prepared in duplicate (n=4 plates).

For each culture or combination, 150 mL cups were filled with the respective pepperoni analogue batter and tightly closed. These cups were also incubated at 30° C. and analyzed (0 h, 14 h, 18 h, 24 h, 44 h and 68 h) in parallel to the microbiological investigations. The pH value was measured in triplicate, using a pH-meter (WTW pH 537 Xylem Analytics Germany Sales GmbH & Co. KG, Weilheim, Germany).

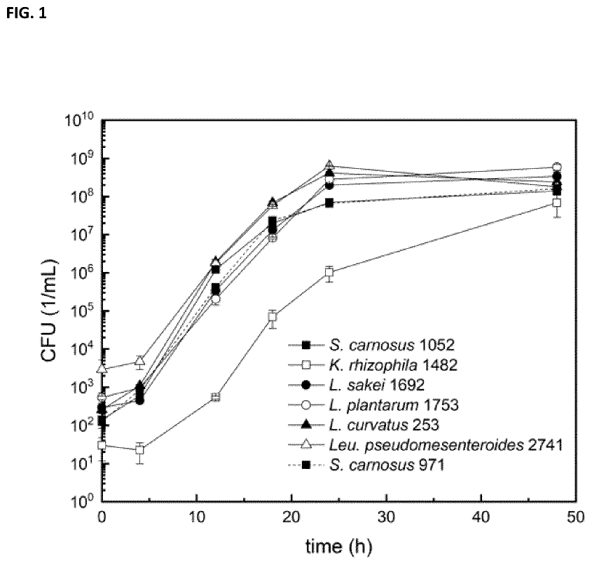

For a general understanding of the growth behavior of each strain, the growth kinetics were initially determined in broth (MRS or nutrient broth) over a period of 48 h at 30° C. As can be seen in FIG. 1, six of the seven investigated starter cultures showed a very similar growth behavior and the stationary phase was reached after ˜24 h of incubation at 30° C. (10⁸-10⁹ CFU/mL). Differences regarding the kinetics were found for K. rhizophila 1482 which could be attributed to the lower initial inoculation concentration (3.00·10¹±1.8·10¹ CFU/mL) as compared to the other strains. However, later experiments showed that this strain is generally more sensitive (e.g. towards the incubation temperatures used).

To evaluate the growth behavior in the pepperoni analogue matrix, experiments were carried out over a period of 68 h (30° C.). Besides the seven starter cultures, two starter culture mixtures (one Lactobacillus strain & one Staphylococcus strain) were investigated. “Mix 1” was composed of L. plantarum 1753 and S. carnosus 1052, whereas “Mix 2” was composed of L. sakei 1692 and S. carnosus 971 (inoculation concentrations used: 10⁶ CFU/g).

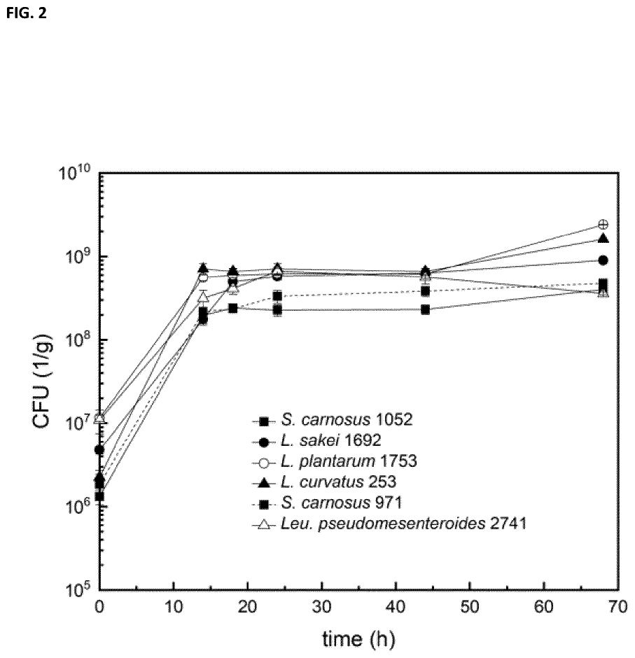

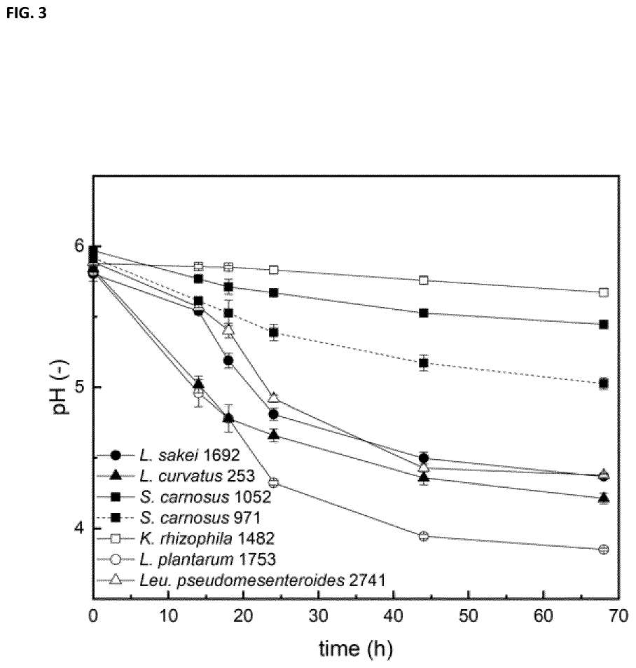

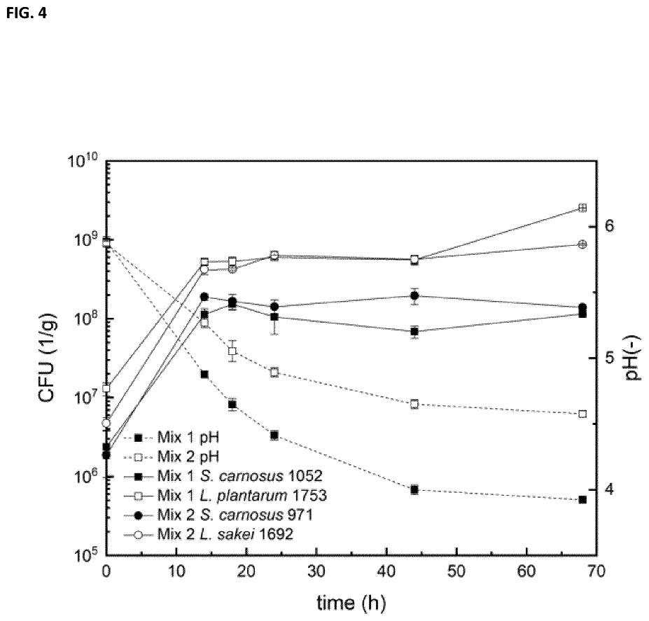

The microbial growth behavior (inoculation concentrations: ˜10⁶ CFU/g) and the decrease in pH (fermentation) in the pepperoni analogue matrices is presented in FIG. 2 and FIG. 3, respectively. Viable counts of K. rhizophila were hard to detect and are not further presented. Except for K. rhizophila, all starter cultures reached cell counts of >10⁸ CFU/g in less than 14 h of incubation at 30° C. Organic acid production led to a remarkable pH drop from initially ˜6.0 to 4.6-4.0 after 68 h of fermentation at 30° C., depending on the starter culture used. Results are hence promising with regard to the fermentation of, and hence acid production in, plant protein-based pepperoni analogues, which is also reflected in the fermentation trials with starter culture mixtures (FIG. 4).

The pH-values determined during fermentation in pepperoni analogues containing one of the Staphylococcus spp. or K. rhizophila (FIG. 3) were found to be around 5.0-5.8. The slight decrease in pH observed in these samples could be attributed to lactic acid bacteria being present in the pepperoni analogue matrix (autochthone microflora).

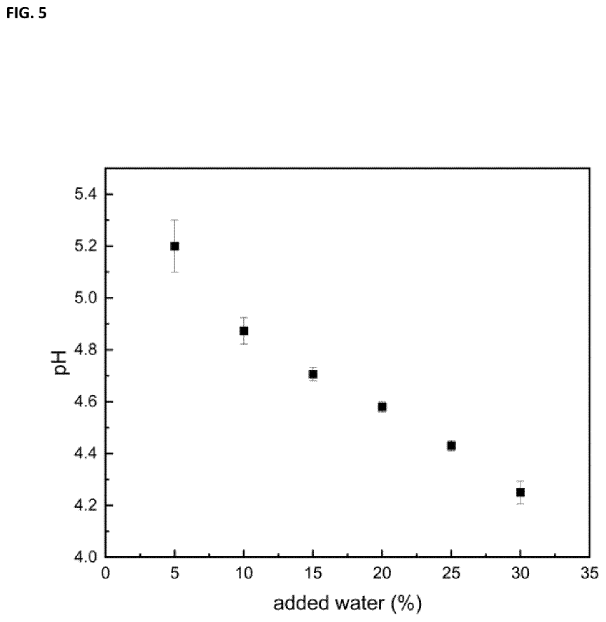

Plant protein-based pepperoni analogues that have been produced with the starter culture mix 1 (L. plantarum 1753 and S. carnosus 1052; 10⁶ CFU/g) showed differences in their final product pH. The pH of the different pepperoni batches dropped from initially 5.6-5.7 to pH values between 5.3-4.2 depending on the formulation used with increasing added water contents (5-30%) leading to lower pH values (FIG. 5). The final pH of sausages that have been produced with 7.8 g/kg GDL (glucono delta lactone), 20% water, and 40% extrudate was 5.2. These results demonstrate that the matrix allows growth of usual meat starter cultures, without sugar addition. This is surprising as addition of sugar is usually necessary to support growth of starter culture in fermented meat products.

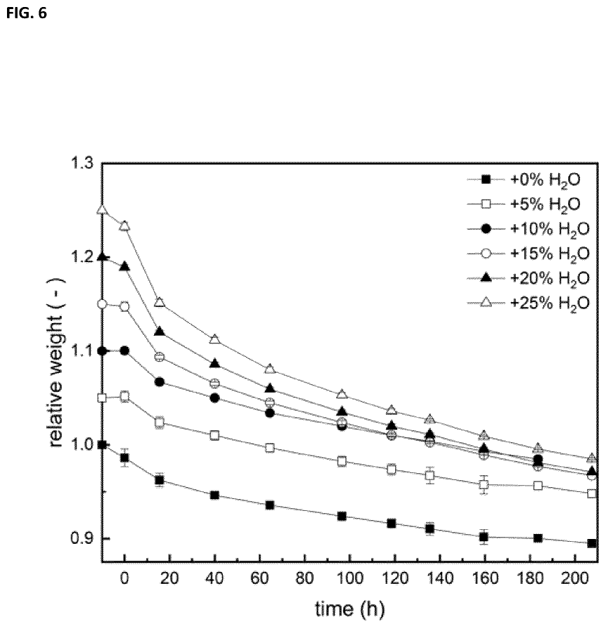

FIG. 6 shows the drying kinetics of the different pepperoni analogues that were produced with different amounts of additional water (0-25%). As can be seen in FIG. 6, the pepperoni analogues lost around 0-2% weight during the heating step (Data points t=−5, 0) and around ⅓ of the total weight loss occurred during the first 16 h of drying at 15° C. and 80% RH (phase with the highest drying speed). The drying kinetics of the different samples were monitored over a period of ˜207 h.

### Example 2

### Preparation of Vegan Pepperoni Analogues

Production of the vegan pepperoni analogue was based on a high water to gluten ratio. Pepperoni analogues were produced containing either pea protein isolate (PPI A/PPI B) or soy protein isolate (SPI). Since previous experiments showed that the fat content has a remarkable influence on the overall binding and cohesiveness of the vegan pepperoni analogues, samples with high (20%) and low (15%) amounts of fat mimetic were produced. All pepperoni analogues were fermented with the Nestlé starter culture L. sakei 1692.

Starter cultures were plated on MRS agar from frozen stock and incubated 48 h at 30° C. under anaerobic conditions. One colony was then transferred into fresh MRS broth and incubated for 24 h at 30° C. This step was repeated once. Afterwards, 35 mL of the starter culture in broth were transferred to a centrifuge tube and centrifuged at 4° C. and 10000 rpm for 8 min. The supernatant was discarded, and the remaining pellet then re-suspended in 5 mL water. Preparation of L. sakei 1692 was timed, so that the culture was ready to use right before production. Pea and soy protein solutions were produced the day before production. For the 5% suspension, 5% protein isolate and 95% water and for the 10% suspension, 10% protein isolate and 90% water were mixed using a hand stirrer. For an increased solubility of proteins, part of the salt was already added in this step leading to a NaCl concentration of 2% in the respective suspensions. The suspensions were prepared for each batch separately and then stored for 18 h in a cooling house at 1° C. Pea A refers to PPI A. Pea B refers to PPI B.

Table 2 below shows the main ingredients of the vegan pepperoni analogues

| | | | | | Protein | |
|---|---|---|---|---|---|---|
| Batch | TVP | Fat | Gluten | Liquid | concentration | Comment* |
| 1 | 30 | 20 | 20 | 30 | 0 | Control |
| 2 | 30 | 20 | 20 | 30 | 10 | 10% A, hf |
| 3 | 30 | 20 | 20 | 30 | 10 | 10% B, hf |
| 4 | 30 | 20 | 20 | 30 | 10 | 10% SPI, hf |
| 5 | 35 | 15 | 20 | 30 | 10 | 10% A, lf |
| 6 | 35 | 15 | 20 | 30 | 10 | 10% B, lf |
| 7 | 35 | 15 | 20 | 30 | 10 | 10% SPI, lf |
| 8 | 35 | 20 | 20 | 25 | 10 | 10% SPI, ll |
| 9 | 30 | 20 | 20 | 30 | 5 | 5% SPI, hf |

*A = PPI A, B = PPI B, SPI = soy protein isolate, lf = 15% fat, hf = 20% fat, ll = 25% liquid; control = sample V3.6

Table 3 below shows the spices and additives added to each batch (note: no dextrose was added)

| Additive | % |
|---|---|
| Salt | 1.7 |
| Paprika mild | 0.7 |
| Cayenne pepper | 0.4 |
| Paprika hot | 0.5 |
| Salami aroma | 0.6 |
| Spice mix purporc | 0.6 |
| Beetroot | 2 |

A fat mimetic was produced. An emulsion composed of 70% (w/w) oil-phase and 30% of a 12% soy protein isolate (SPI) suspension was made, resulting in a total concentration of 3.6% SPI in the emulsion. An oil phase containing pure canola oil was pre-heated to 40° C. First, a SPI suspension was prepared in a colloid mill (MaxxDLab FrymaKoruma AG, Rheinfelden, Switzerland) then, the oil phase was slowly added to the SPI suspension and emulsified during constant mixing. When all the oil was mixed in, a transglutaminase (TG) solution containing 25 mg TG/g, SPI was added using the MADO bowl chopper (MTK 661 MADO GmbH, Dornhan, Germany). The emulsion was filled into sterile casings using a piston filler (WMF 591 MADO GmbH, Dornhan, Germany) and heat treated in a heating chamber (UK 1800 BE, Reich Thermoprozesstechnik GmbH, Germany). First, it was heated to a core temperature of 40° C. which was kept constant for one hour to ensure crosslinking of proteins by transglutaminase. Next, the product was heated at a chamber temperature of 90° C. until a core temperature of 85° C. was reached and cooled with a cold shower for 10 min, before storing at 2° C.

Since different amount of fat were used for each batch, the fat mimetic could not be chopped together with the extrudate but was chopped separately in a bowl chopper cut into ˜5 cm cubes (Type K64—Seydelmann GmbH, Stuttgart, Germany) for 10 s at 1500 rpm. After defrosting the extrudate at +1° C. for 48 hours, it was chopped in a 60 L bowl chopper (Type K64—Seydelmann GmbH, Stuttgart, Germany) at a cutting speed of 1500 rpm for 75 s.

Each batch was prepared separately according to the recipe stated in Table 2. First, the chopped fat mimetic was mixed by hand with half of the amount of gluten until the surface of the mimetic was completely covered. The TVP was mixed by hand with the other half of the gluten and the spices as stated in Table 3 until all ingredients were homogenously distributed. Afterwards, the fat was added to the TVP and mixed in. Depending on the composition of the liquid phase, beetroot powder, the remaining salt and the concentrated starter culture were mixed into the protein suspension or water. The liquid phase was then slowly added to the pepperoni analogue mass under constant mixing by hand. Starter culture concentration was set to be ˜10⁶ CFU/g. Pepperoni analogues were filled into cellulose casings (ø49 mm Nalo Faser P-U, Kalle GmbH, Wiesbaden) using a vacuum filler (Type VF 610 plus, Handtmann GmbH, Biberach, Germany) and then fermented and heated in a cooking-smoking chamber (Type Airmaster UK 1800BE, Reich Thermoprozesstechnik GmbH, Schechingen Germany). After fermentation for 24 h at 22° C. and 95% RH, heating was performed at 90° C. using steam cooking until the pepperoni analogues reached a final internal temperature of 85° C. Afterwards, the analogues were showered with cold water (10° C.) for 10 min and then smoked twice at 20° C. for 5 min with friction smoke from beech wood. Pepperoni analogues were then dried at 15° C. and 80-85% RH for 48 h.

To track the fermentation process, cups were filled with the pepperoni mass from each batch and the pH-value measured right after production, after 20 h, 22 h and 24 h. The pH-value in the final product was recorded after heat processing and drying. Table 4 below shows the change of pH value over duration of production. Samples were inoculated with L. sakei 1692 (10⁶ CFU/g) and fermented for 24 h at 22° C. Standard deviation is not shown but was below ±0.06 for all samples (n=3).

TABLE 4

| Sample | 0 h | 20 h | 22 h | 24 h | Product |
|---|---|---|---|---|---|
| control | 5.73 | 5.32 | 5.23 | 5.16 | 5.03 |
| 10% A, hf | 5.90 | 5.50 | 5.38 | 5.35 | 5.16 |
| 10% B, hf | 5.85 | 5.57 | 5.49 | 5.41 | 5.17 |
| 10% SPI, hf | 5.82 | 5.55 | 5.49 | 5.35 | 5.11 |
| 10% A, lf | 5.88 | 5.63 | 5.53 | 5.42 | 5.17 |
| 10% B lf | 5.85 | 5.59 | 5.49 | 5.38 | 5.17 |
| 10% SPI, lf | 5.83 | 5.55 | 5.50 | 5.39 | 5.19 |
| 10% SPI, ll | 5.77 | 5.63 | 5.56 | 5.49 | 5.30 |
| 5% SPI, hf | 5.76 | 5.50 | 5.41 | 5.30 | 5.05 |

A = PPI A,
B = PPI B,
SPI = soy protein isolate,
lf = 15% fat,
hf = 20% fat,
ll = 25% liquid;
control = sample V3.6

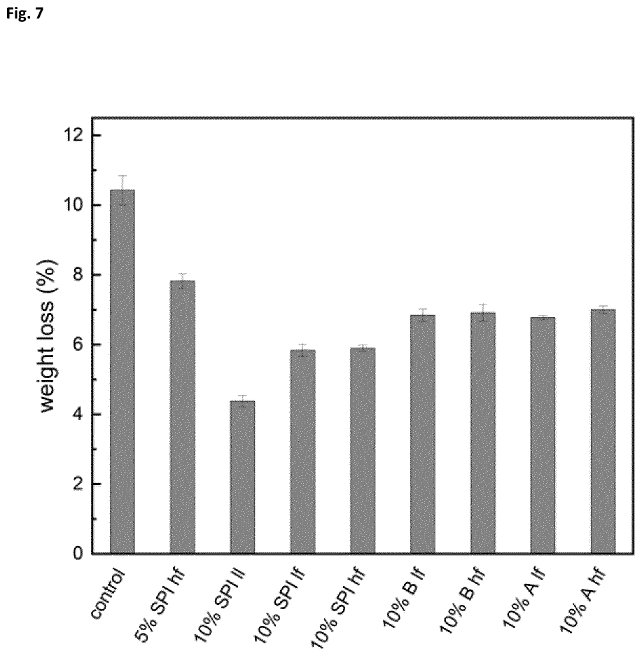

Looking at the pH-values stated in Table 4, it can be seen that the control and the sample with only 5% SPI reached lower pH values (5.03-5.05) compared to the other samples (5.11-5.3). The pepperoni analogue that was produced with 10% SPI suspension and a low liquid amount had the highest pH-value with 5.30. The reason for this might be the water binding capacity of the added protein and the thereby lower water availability. This has a direct influence on the growth behavior of microorganisms. The weight loss results that are presented in FIG. 7, show the same trend. The less protein was added, the higher was the observed weight loss. Here, it can also be seen that samples produced with SPI have a slightly lower weight loss when compared to samples produced with pea protein suspensions. An influence of the amount of added fat on the weight loss could not be observed.

Internal sensory was carried out right after the drying step. For the sensory, unbaked samples were sliced in 2 mm thick slices. Criteria to be evaluated were the sliceability, cohesiveness, fat visibility, color, and juiciness. It was also checked if beany notes or graininess could be perceived on the tongue. The results are presented in Table 5 below and in FIG. 8.

TABLE 5

| | Slice- | Cohesive- | Fat | | | | |
|---|---|---|---|---|---|---|---|
| Sample | ability | ness | visibility | Color | Juiciness | Beany | Grainy |
| control | − | − | ++ | + | ++ | No | No |
| 10% A, hf | + | 0 | + | +* | + | Yes | No |
| 10% B, hf | + | 0 | 0 | +* | + | No | No |
| 10% SPI, hf | + | + | + | + | + | No | No |
| 10% A, lf | ++ | + | 0 | +* | 0 | No | Yes |
| 10% B, lf | + | 0 | − | +* | 0 | No | No |
| 10% SPI, lf | ++ | ++ | − | + | 0 | No | No |
| 10% SPI, ll | ++ | ++ | 0 | + | 0 | No | No |
| 5% SPI, hf | + | + | ++ | + | + | No | No |

*color appeared brighter than for other samples; scale from −− (very bad) to ++ (very good)
A = PPI A, B = PPI B, SPI = soy protein isolate, lf = 15% fat, hf = 20% fat, ll = 25% liquid; control = sample V3.6

Different trends could be observed. With a lower amount of fat mimetic in the mass, the fat visibility got worse but the cohesiveness and sliceability seemed to be improved. Samples with a high fat concentration were also described as juicier. The soy protein isolate appeared to have better water binding capacities when compared to the pea protein isolates. This resulted in a slightly better sliceability and cohesiveness without decreasing the processability and therefore the fat visibility.

### Example 3

### Sensory Analysis of Samples Baked on Pizza

For the pizza sensory, four of the nine samples were selected and baked on a pizza. The control, samples with 10% SPI with high and low amount of fat and the sample with 5% SPI were sliced in 2 mm thick slices and placed on store bought pre-baked pizza doughs. The pizza was topped with tomato sauce and a pizza-cheese mix. Pepperoni analogue slices were placed on top. The pizzas were baked at 180° C. for 12 min.

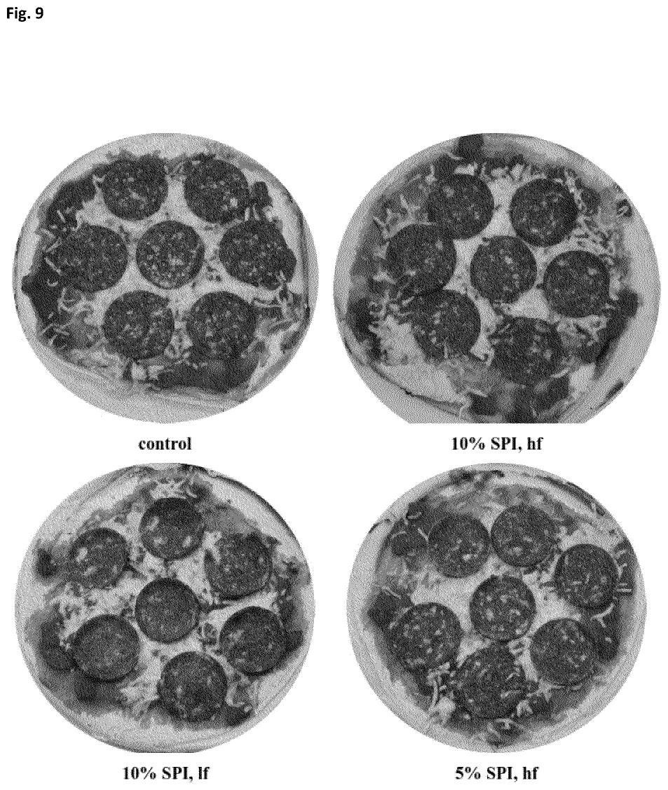

Only the sample with 10% SPI and low fat was described as “different to the others”. This pepperoni analogue was perceived as a bit dryer and harder as compared to the other samples. The interpretation of this result differed in between the testers with some of them not associating it with a negative quality attribute since the slice of the pepperoni analogue was more noticeable on the pizza, what they considered more similar to a “normal” pepperoni. Also, a slight cupping effect could be seen during baking (FIG. 9). In general, all samples were acceptable, had a good taste and no negative perception was described. The texture of the slices could, with exception for the above mentioned (10% SPI, If), almost not be noticed, neither in a negative nor in a positive manner.

This production showed again the potential of protein isolate suspensions as a binding increaser while maintaining a good processability of the pepperoni analogue mass. It could be seen that the water binding and cohesiveness of pepperoni analogues produced with SPI was even better than samples produced with pea protein isolates. Therefore, the low level (5% SPI suspension) of added protein isolate already led to a well bound product with a very good fat visibility. Pepperoni analogues produced with less fat showed a higher cohesiveness and sliceability, however the juiciness and fat visibility decreased a little.

Regarding the production one can conclude that mixing part of the gluten with the chopped fat (until the surface of the mimetic is fully covered) prior mixing the fat mimetic with other ingredients, has a positive influence on the binding and may hence be the reason for the observed, improved fat embedment.

A very important point for further consideration is the sliceability of samples for industrial processing. As it can be seen in Table 5 the control was rated best with regard to fat appearance and juiciness, but bad in terms of sliceability and cohesiveness (exclusion criterion).

### Example 4

### Development of a Plant Protein-Based Salami Cold Cut Analogue

The texture, particularly the firmness and bite of the salami analogues could be increased. To enhance the firmness, salami analogues were dried, the protein content was increased, and the ratio of binder and extrudate was modified with the intention to increase the firmness at first bite.

As before, for the production of animal fat mimetics, canola oil was heated to 60° C. in a stainless steel pot on a stove. 12% (w/w) SPI powder was dispersed with tab water using a rotor-stator homogenizer at 3500 rpm for 5 min. Pre-heated canola oil (60° C.) was then emulsified with the SPI suspension in the rotor-stator homogenizer at 5000 rpm for 5 min. The emulsion was then transferred to a K20 bowl chopper and let for cooling to 37° C. before adding transglutaminase (50 mg TG/g SPI; speed setting 1, 15 rounds) and then wheat fibers (speed setting 1, 10 rounds). Emulsion was then filled into plastic casings using a piston filler. After incubation (core temperature 40° C., 1 h) and subsequent pasteurization (heating to 85° C.) of emulsions in a steam chamber (Airmaster UK, 7146 1800 BE-FR 702), they were stored at 4° C. until use for production of plant-based salami analogues.

The following batches were produced:
Batch 1: Control (based on the formulation from the previous experiment).
Batch 2: Increased amount of SPI in protein suspension (12% SPI).
Batch 3: Extrudates with soy protein (‘chicken extrudate’) instead of pea protein extrudate.
Batch 4: Mixture (1:1) of soy and pea protein extrudates.
Batch 5: Pre-cutting animal fat mimetics with a meat dicer before directly chopping these dices together with the other components in the bowl chopper. Pre-cutting the fat mimetics to dices of approx. 1 cm edge length might lead to a more homogenous fat particle size distribution.
Batch 6: Increased the amount of extrudate (pea protein extrudate) and decreasing gluten. Increasing the extrudate to binder ratio might enhance the texture, eventually leading to a firmer impression at the “first bite”.

An overview of the batches with the formulation of the main components is given in Table 6 and the detailed composition is given in Table 7. For all batches, transglutaminase was added to the protein suspension and the same animal fat mimetics were used for all sausages. For each batch, 2 sausages were dried after pasteurization in order to investigate whether this would lead to a better texture by increasing the firmness.

TABLE 6

| | Batch 1 | Batch 2 | Batch 3 | Batch 4 | Batch 5 | Batch 6 |
|---|---|---|---|---|---|---|
| Description: | Control | 12% SPI | 100% soy | 50% soy | pre-cutting | higher |
| | | in binder | extrudate | extrudate, | fat with | extrudate- |
| | | | | 50% pea | dicer | gluten |
| | | | | extrudate | | ratio |

Main components of plant-based salami analogues (spices, etc. are added on top to this formulation)

| | | | | | | |
|---|---|---|---|---|---|---|
| Extrudate | 14% | 14% | 14% | 14% | 14% | 18% |
| Animal fat mimetics | 20% | 20% | 20% | 20% | 20% | 20% |
| Gluten | 26% | 26% | 26% | 26% | 26% | 22% |
| Protein suspension | 40% | 40% | 40% | 40% | 40% | 40% |
| Total | 100% | 100% | 100% | 100% | 100% | 100% |

Protein suspension

| | | | | | | |
|---|---|---|---|---|---|---|
| SPI (in suspension) | 10% | 12% | 10% | 10% | 10% | 10% |
| Water (in suspension | 90% | 88% | 90% | 90% | 90% | 90% |
| SPI (in total) | 4.00% | 4.80% | 4.00% | 4.00% | 4.00% | 4.00% |
| Water (in total) | 36.00% | 35.20% | 36.00% | 36.00% | 36.00% | 36.00% |

For batches with 10% SPI in the protein suspension, SPI powder was dispersed with water in a K64 bowl chopper together with all spices (as given in Table 7). Preparing this mix of protein suspension with spices was done in a mixer (Stephan Universal Machine UMC 12) for batch 2 (with 12% SPI in the protein suspension). These suspensions were stored at 2° C. over night before use. For batch 1-4 and batch 6, animal fat mimetics were diced (˜2 cm edge length) using a meat dicer and then pre-chopped with a K64 bowl chopper at 1500 rpm for 10 s. For batch 5, smaller dices of fat mimetics were cut with the dicer that were later added directly to for chopping together with the rest of the ingredients. Thawed protein extrudates (2° C.) were comminuted with a K64 bowl chopper at 1500 rpm for 75 s and then the amounts weighted for the individual batches.

The pre-comminuted animal fat mimetics that were coated with gluten by mixing with gluten powder and then added to comminuted extrudates and mixed with the protein suspension, spices, transglutaminase (0.2%) and starter cultures (0.25 g/kg sausage mass) for 240 s with backwards rotating knifes in the bowl chopper. Subsequently the mixture was filled into cellulose casings using a vacuum filler hung into a steam chamber. After fermentation for 22 h at 22° C. the pH had reached 5.30±0.05 (see Table 8) and sausages were then pasteurized (heating to 85° C. core temperature) followed by cooling with a water shower for 1 h. All sausages were smoked twice for 5 min. Undried samples were then packed, whereas the rest of the sausages was dried for 43 h (15° C., 75% relative humidity).

Table 7 shows the detailed formulation of plant-based salami analogues including spices.

Components

| | Batch 1-5 | Batch 6 |
|---|---|---|
| Main components | | |
| Extrudate | 12.95% | 16.65% |
| Animal fat mimetics | 18.50% | 18.50% |
| Gluten | 24.05% | 20.35% |
| Protein suspension | 37.00% | 37.00% |
| Spices | | |
| Salt | 1.85% | 1.85% |
| Red bell pepper (powder) | 0.46% | 0.46% |
| Salami aroma (pur porc, | 0.74% | 0.74% |
| Westfalia) | | |
| Salami aroma (Givaudan) | 0.56% | 0.56% |
| Beet root powder | 2.78% | 2.78% |
| MSG | 0.09% | 0.09% |
| Garlic paste | 0.93% | 0.93% |
| White pepper | 0.09% | 0.09% |

Table 8 shows the pH of salami analogues after fermentation with starter cultures.

| Time (h) | Batch 1 | Batch 2 | Batch 3 | Batch 4 | Batch 5 | Batch 6 |
|---|---|---|---|---|---|---|
| 0 | 5.96 | 5.97 | 5.90 | 5.94 | | 5.94 |
| 22 | 5.28 | 5.32 | 5.25 | 5.35 | | 5.27 |
| 71 (not dried) | 5.36 | 5.44 | 5.40 | 5.44 | 5.44 | 5.37 |
| 71 (dried) | 5.33 | 5.47 | 5.38 | 5.10 | 5.44 | 5.33 |

Table 9 shows the weight loss of salami analogues during drying.

| Time (h) | Batch 1 | Batch 2 | Batch 3 | Batch 4 | Batch 5 | Batch 6 |
|---|---|---|---|---|---|---|
| 19 | 3.9% ± 0.3% | 3.6% ± 0.5% | 4.4% ± 0.2% | 4.3% ± 0.2% | 4.4% ± 0.2% | 5.3% ± 0.3% |
| 27 | | 4.4% ± 0.4% | | | | 6.3% ± 0.2% |
| 43 | 5.8% ± 0.2% | 5.6% ± 0.4% | 6.6% ± 0.1% | 6.5% ± 0.2% | 6.5% ± 0.1% | 7.7% ± 0.1% |

Sausages containing soy protein extrudate (batch 3 and 4) dried somewhat faster than the control (batch 1) with pea protein extrudate. Samples with increased amount of extrudate and less gluten showed the highest weight loss after 43 h (batch 6).

A visual and sensorial evaluation of the batches was made.

Batch 2: Increasing the amount of SPI in the protein suspension from 10% to 12% SPI increased the firmness and sliceability. However, the texture was also perceived as gummier.

Batch 3: Using the soy protein extrudate instead of pea protein extrudate led to a texture that was less firm, but crumblier. The color was slightly more red for these sausages.

Batch 4: In a mixture (1:1) of soy and pea protein extrudates the negative effects (decrease in firmness and cohesiveness) were less pronounced than in batch 3.

Batch 5: Pre-cutting animal fat mimetics with a meat dicer before directly chopping these dices together with the other components in the bowl chopper was shown to be feasible. The fat particle size distribution was appeared slightly more homogenous. Firmness and cohesiveness seemed to be slightly decreased compared to the control, however, the dried version of this batch received good feedback during tasting.

Batch 6: An increased amount of extrudate (and thereby decreased amount of gluten), led to a texture that was less firm and cohesive. The crumbly texture was not only perceived during consumption, but also decreased sliceability compared to the control. However, it should be noted that handling during filling was better compared to the control.

Sliceability of all salamis was rated as good, and the firmness and cohesion of sausages allowed slicing thinner slices of 1-1.5 mm. With decreased slice thickness, the negative perceived gumminess was eliminated. Most of the panelists preferred the taste of this extrudate.

For dried salamis, the differences between the batches, as described above, were still noticeable. The firmness of all batches was increased which was generally perceived as positive and also improved sliceability. The color of all batches was darker after drying, which was also considered as an improvement. In addition, due to drying the surface was not moist which will likely improve microbiological stability during storage. Results also showed that the addition of transglutaminase to the protein suspension results in a texture that is quite firm and cohesive and samples that are well sliceable. This effect can be enhanced by increasing the amount of protein within the suspension.

1. A method of making a vegan fermented pepperoni or salami analogue product, said method comprising
a. Preparing a pepperoni or salami analogue batter mixture, said mixture comprising
i. plant protein extrudate,
ii. bacterial culture comprising Lactobacillus,
iii. fat mimetic,
iv. gluten,
v. additives, and
vi. water;
b. Ripening the mixture;
c. Heating the mixture to a temperature of at least 70° C.; and
d. Drying the mixture at a relative humidity of 90% or less to form a vegan fermented pepperoni or salami analogue product.

2. The method according to claim 1, wherein the plant protein extrudate is texturized and has a dry matter content of 45 to 60 wt %.

3. The method according to claim 1, wherein the bacterial culture comprises Lactobacillus sakei, Lactobacillus plantarum, and Lactobacillus curvatus.

4. The method according to claim 1, wherein the bacterial culture further comprises Staphylococcus carnosus.

5. The method according to claim 1, wherein the batter mixture is devoid of added sugar.

6. The method according to claim 1, wherein the fat mimetic comprises an oil phase and a soy protein isolate (SPI) suspension.

7. The method according to claim 1, wherein the plant protein extrudate and fat mimetic are comminuted before adding to the batter mixture.

8. The method according to claim 1, wherein the batter mixture comprises between 5 to 50 wt % water.

9. The method according to claim 1, wherein the pepperoni batter mixture comprises 40-50 wt % plant protein extrudate and 10-20 wt % water before ripening.

10. The method according to claim 1, wherein the pepperoni batter mixture comprises about 20 wt % fat mimetic and about 20 wt % wheat gluten before ripening.

11. The method according to claim 1, wherein the pepperoni or salami batter mixture further comprises soy protein isolate or pea protein isolate, present in the water.

12. The method according to claim 1, wherein the pepperoni or salami batter mixture is ripened until it reaches pH 4.6 to 6.0.

13. The method according to claim 1, wherein the pepperoni or salami batter mixture is subjected to a smoking step after ripening.

14. The method according to claim 1, wherein the pepperoni or salami batter mixture loses between 5-20% of its original weight during drying.

15. A fermented pepperoni or salami analogue product comprising plant protein extrudate, fat mimetic, gluten, and additives.

16-17. (canceled)
